(19) United States
(12) Patent Application Publication
(10) Pub. No.: US 2025/0216065 A1
(43) Pub. Date: Jul. 3, 2025

(54) STRING LAMP HOUSING STRUCTURE

(71) Applicant: Fude Yang, Dongguan City (CN)

(72) Inventor: Fude Yang, Dongguan City (CN)

(21) Appl. No.: 18/420,107

(22) Filed: Jan. 23, 2024

(30) Foreign Application Priority Data
Dec. 29, 2023 (CN) 202323624104.3

(51) Int. Cl. F21V 31/00; F21S 4/10; F21V 3/06; F21V 15/01; F21V 19/00

(52) U.S. Cl. CPC F21V 31/005; F21V 15/01; F21V 19/0005; F21S 4/10; F21V 3/062

(57) ABSTRACT

A string lamp housing structure, Since the lamp shade and the connecting base in the present disclosure are molded as one piece by means of injection, the lamp shade may be larger than the connecting base and may be in other shapes, which removes limits on the size and shape of the lamp shade and realizes diversified modeling of the lamp shade; it may also be designed to be a structure where the lamp shade is sleeved by a protection housing, thereby providing diversified modeling for the lamp shade protection housing, and providing different lighting effects; meanwhile, good waterproof effect can be achieved.

### CROSS-REFERENCE TO RELATED APPLICATION

The present application claims priority to Chinese Patent Application No. 202323624104.3, filed on Dec. 29, 2023, the entire contents of which are incorporated herein by reference.

### TECHNICAL FIELD

The present disclosure relates to the technical field of string lamps, and particularly relates to a string lamp housing structure.

### BACKGROUND

Widely used for indoor and outdoor decorations, string lamps are essential for decorations of festival celebration. String lamps mainly refer to decorative lamps installed in series in an electrical circuit. Generally, a string lamp comprises a long and thin bulb, a lamp base for fixing the bulb, and a connecting base for realizing electric connection between the bulb and a conducting wire.

For the purpose of protection, lamp beads in existing string lamps, together with pins, are usually in sleeve connection in a one-piece transparent connecting base, and a tail part of the transparent connecting base is blocked by a rubber plug in cooperation with glue; however, when the one-piece transparent connecting base is used for protecting the lamp beads, the inner structure of the connecting base and lamp bead pins will also be seen, which affects its appearance in decoration. Therefore, a string lamp housing structure is provided here, so as to solve the afore-mentioned problem.

### SUMMARY

The technical solution below is adopted in the present disclosure, so as to solve the afore-mentioned problem: a string lamp housing structure, comprising:
a connecting base having a hollow sleeve structure;
a lamp shade provided at a front end of the connecting base and being an injection-molded one-piece structure with the connecting base;
a lamp bead assembly plugged into the connecting base and having a top end abutting against or provided in the lamp shade; and
a soft plug sleeving the lamp bead assembly and plugged, together with a front end of the lamp bead assembly, into the connecting base.

As a preferable technical solution of the present disclosure, after the lamp shade and the connecting base are molded as one piece via injection, the lamp shade is sleeved by a lamp shade protection housing, and a joint between the connecting base and the lamp shade protection housing is fixed by a convex rib.

As a preferable technical solution of the present disclosure, the lamp bead assembly comprises a lamp bead body, a first pin and a second pin, wherein the lamp bead body extends through the connecting base into the lamp shade, one end of the lamp bead body is connected with the first pin, one end shared by the lamp bead body and the first pin is connected with the second pin, and both the first pin and the second pin extend out of the connecting base.

As a preferable technical solution of the present disclosure, one end of the lamp shade at the connecting base is provided with a lamp bead placing groove, one end of the lamp shade at the lamp bead placing groove is provided with a first clamping ring, one end of the connecting base at the lamp shade is provided with a first clamping groove inside, the first clamping groove is in clamping connection to the first clamping ring, the lamp shade is positioned at one end of the first clamping ring at the connecting base, and the lamp bead body extends through the connecting base into the lamp bead placing groove.

As a preferable technical solution of the present disclosure, one end of the connecting base away from the lamp shade is provided with a second clamping groove inside, and one end of the connecting base at the second clamping groove is provided with a reinforcing ring.

As a preferable technical solution of the present disclosure, one end of the lamp bead body is connected with a first pin, one end shared by the lamp bead body and the first pin is connected with a second pin, and both the first pin and the second pin extend out of the connecting base.

As a preferable technical solution of the present disclosure, one end of the connecting base opposite to the lamp shade sleeves a soft plug, one side of the soft plug is provided with a first relief hole, the other side of the soft plug is provided with a second relief hole, the first relief hole is clamped with the first pin inside, and the second relief hole is clamped with the second pin inside.

As a preferable technical solution of the present disclosure, the soft plug is provided with a second clamping ring at outside, the second clamping ring is clamped inside the second clamping groove, and the soft plug is provided with a separator between the first pin and the second pin.

As a preferable technical solution of the present disclosure, both the first clamping groove and the second clamping groove have a ring structure, and a middle part at one end of the lamp shade is provided to be a conical groove.

As a preferable technical solution of the present disclosure, shapes of the lamp shade protection housing comprise: a ball shape, a water-drop shape, and a bullet shape.

The present disclosure can produce the following beneficial effects:

Since the lamp shade and the connecting base in the present disclosure are molded as one piece by means of injection, the lamp shade may be larger than the connecting base and may be in other shapes, which removes limits on the size and shape of the lamp shade and realizes diversified modeling of the lamp shade.

Since the lamp shade and the connecting base are molded as one piece by means of injection, it may be designed to be a structure where the lamp shade is sleeved by a protection housing, thereby providing diversified modeling for the lamp shade protection housing, and providing different lighting effects according to the color of the lamp shade protection housing.

The connecting base and the lamp shade are made of different materials and are modeled as a one-piece integral structure, so that the lamp bead body, associated with the first pin and the second pin, can pass through a tail end of the connecting base; AB adhesive is injected into the connecting base, and the connecting base is sealed with the cooperation of the soft plug; besides, the connecting base is made of an opaque plastic material, and the lamp shade is made of a transparent plastic material, as a result, messy lines and interior structure can be effectively covered, which makes the integral structure more exquisite and beautiful; moreover, the lamp shade does not affect normal light-emitting of the lamp bead body, and the soft plug is used for sealing so as to prevent the lamp bead assembly from falling off; and the first pin and the second pin of the lamp bead are separated so as to avoid short circuit; meanwhile, good waterproof effect can be achieved.

### DESCRIPTION OF DRAWINGS

FIG. 1 is a structure diagram of the lamp shade having a grid ball shape in the preferable Example 1 of the present disclosure;

FIG. 2 is a structure diagram of the lamp shade having a grid water-drop shape in the preferable Example 1 of the present disclosure;

FIG. 3 is a structure diagram of the lamp shade having a glossy water-drop shape in the preferable Example 1 of the present disclosure;

FIG. 4 is a structure diagram of the lamp shade having a glossy bullet shape in the preferable Example 1 of the present disclosure;

FIG. 5 is a structure diagram of the lamp shade having a grid bullet shape in the preferable Example 1 of the present disclosure;

FIG. 6 is a structure diagram of the connecting base in the preferable Example 2 of the present disclosure;

FIG. 7 is a structure diagram of the preferable Example 3 of the present disclosure;

FIG. 8 is a split structure diagram of the preferable Example 3 of the present disclosure;

FIG. 9 is a split section structure diagram of the connecting base and the lamp shade in a preferable example of the present disclosure.

Marks in the drawings: 1. Connecting base; 101. First clamping groove; 102. Second clamping groove; 103. Reinforcing ring; 2. Lamp shade; 201. Lamp bead placing groove; 202. First clamping ring; 203. Conical groove; 3. Lamp bead body; 301. First pin; 302. Second pin; 4. Soft plug; 401. First relief hole; 402. Second relief hole; 403. Second clamping ring; 404. Separator; 5. Lamp shade protection housing; 6. Convex rib.

### EMBODIMENTS

With reference to the drawings, the technical solution of the present disclosure will be clearly and completely described below. It should be noted that locations or position relationships indicated by “center”, “on/up/above”, “under/down/below”, “left”, “right”, “vertical”, “horizontal”, “inside”, “outside” and other terms in the description of the present disclosure are locations or position relationships indicated based on the drawings, and are merely for the convenience of describing the present disclosure and simplifying the description, rather than indicating or implying that the apparatus or element has to be in a specific location and be configured or operated at a specific location, and thus should not be understood as limits to the present disclosure. Besides, the terms “first”, “second” and “third” are merely used for the purpose of description, and should not be understood as indication or implication of relative significance.

It should be noted that, unless otherwise specified or limited, “mount”, “interconnect”, “connect” and other terms in the present disclosure should be understood in a broad sense, for instance, the parts can be fixedly or detachably connected, or can be integrated as one piece; they can be in mechanical or electric connection; they can be directly connected, and can also be indirectly connected via an inter-mediation, or can be a connection inside two elements. For one skilled in the art, the meaning of the afore-mentioned terms in the present disclosure can be understood according to specific situations.

With reference to the drawings, the present disclosure will be further explained below.

### Example 1

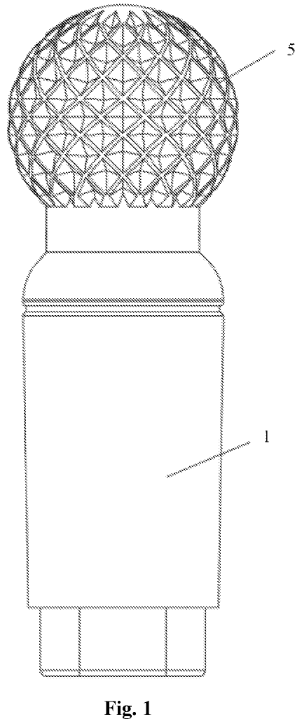

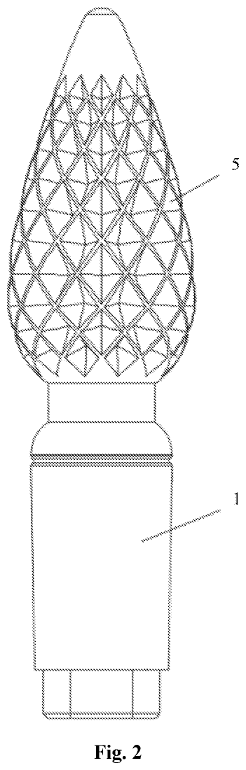

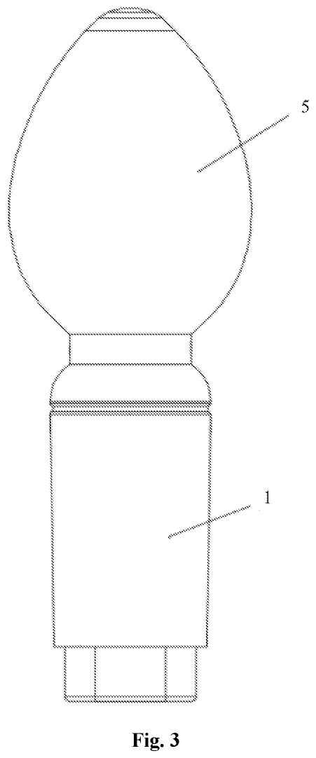

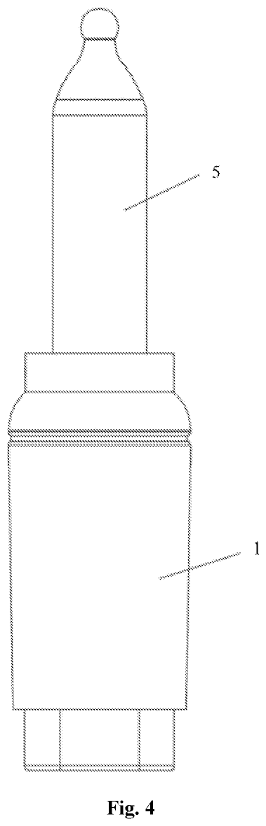

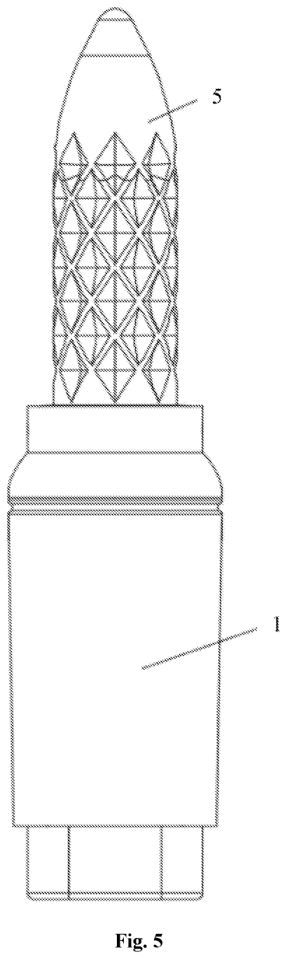

As shown in FIGS. 1 to 5, the present disclosure discloses a string lamp housing structure, comprising: a connecting base 1, a lamp shade 2, a lamp bead assembly, and a soft plug 4, wherein: the connecting base 1 has a hollow sleeve structure; the lamp shade 2 is provided at a front end of the connecting base 1 and is an injection-molded one-piece structure with the connecting base 1, and the lamp shade 2 is made of a PES material; the lamp bead assembly is plugged into the connecting base 1, and has a top end abutting against or provided in the lamp shade 2; the soft plug 4 sleeves the lamp bead assembly and is plugged, together with a front end of the lamp bead assembly, into the connecting base 1; the connecting base 1 and the lamp shade 2, which are in an injection-molded one-piece structure, do not need extra assembling, as a result, the assembly procedures of the string lamp can be reduced, and the assembly efficiency is thus enhanced; the lamp shade 2 may be larger than the connecting base and may be in other shapes, which removes limits on the size and shape of the lamp shade and realizes diversified modeling of the lamp shade; and a structure where the protection housing sleeves the lamp shade 2 can be designed.

The lamp bead assembly comprises a lamp bead body 3, a first pin 301 and a second pin 302, wherein the lamp bead body 3 extends through the connecting base 1 into the lamp shade 2, one end of the lamp bead body 3 is connected with the first pin 301, one end shared by the lamp bead body 3 and the first pin 301 is connected with the second pin 302, and both the first pin 301 and the second pin 302 extend out of the connecting base 1; the shapes of the lamp shade protection housing 5 comprise a ball shape, a water-drop shape, a bullet shape and plural different structures, and lamp shades 2 having different shapes and structures can be applied to different usage scenes.

### Example 2

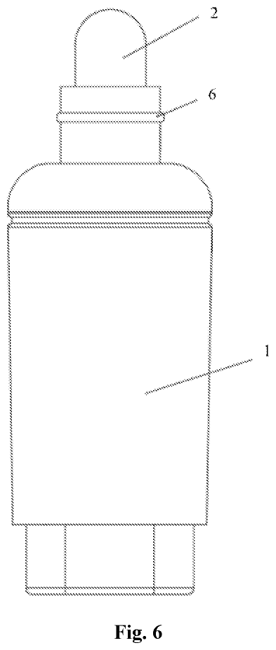

As shown in FIG. 6, after the lamp shade 2 and the connecting base 1 are molded as one piece via injection, the lamp shade 2 is sleeved by a lamp shade protection housing 5, and a joint between the connecting base 1 and the lamp shade protection housing 5 is fixed by a convex rib 6; since the injection-molded one-piece structure of the lamp shade 2 and the connecting base 1 is adopted, a structure where the protection housing sleeves the lamp shade 2 can be designed.

### Example 3

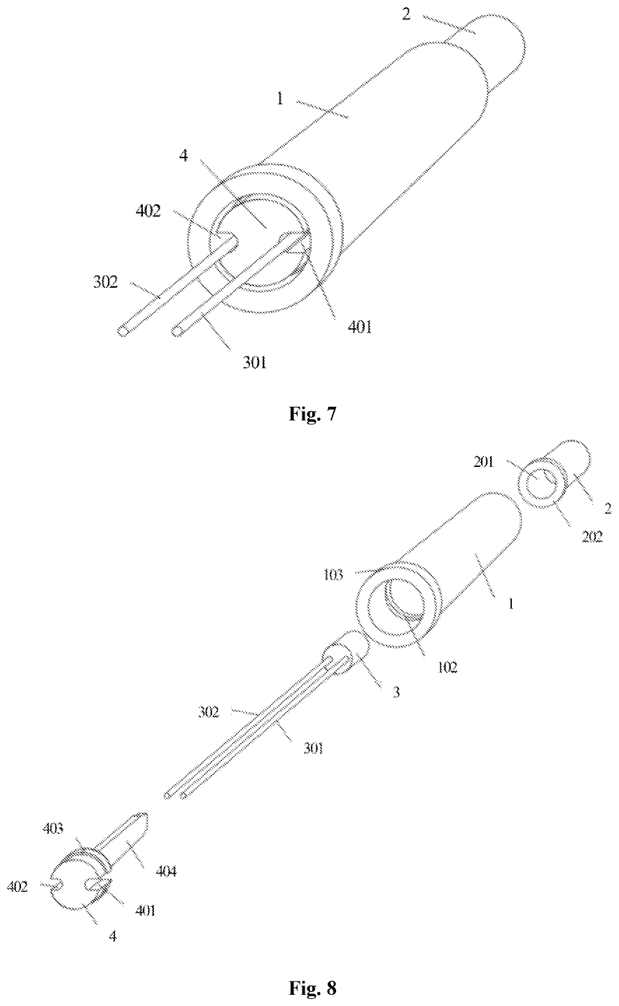

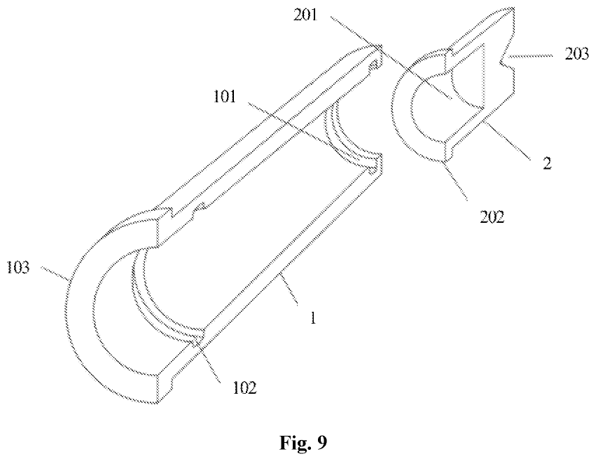

As shown in FIGS. 7 to 9, one end of the lamp shade 2 at the connecting base 1 is provided with a lamp bead placing groove 201, one end of the lamp shade 2 at the lamp bead placing groove 201 is provided with a first clamping ring 202, one end of the connecting base 1 at the lamp shade 2 is provided with a first clamping groove 101 inside, the first clamping groove 101 is in clamping connection to the first clamping ring 202, the lamp shade 2 is positioned at one end of the first clamping ring 202 at the connecting base 1, and the lamp bead body 3 extends through the connecting base 1 into the lamp bead placing groove 201; besides, the lamp shade 2 and the connecting base 1 are made of different plastic materials, wherein: the connecting base 1 is made of an opaque plastic material, and the lamp shade 2 is made of a transparent plastic material, which makes the integral structure more exquisite and beautiful; moreover, the lamp shade 2 does not affect normal light-emitting of the lamp bead body 3.

As shown in FIG. 7, one end of the connecting base 1 away from the lamp shade 2 is provided with a second clamping groove 102 inside, the second clamping groove 102 fits the second clamping ring 403 so as to facilitate limiting of the soft plug 4, and one end of the connecting base 1 at the second clamping groove 102 is provided with a reinforcing ring 103; one end of the lamp bead body 3 is connected with a first pin 301, one end shared by the lamp bead body 3 and the first pin 301 is connected with a second pin 302, and both the first pin 301 and the second pin 302 extend out of the connecting base 1; one end of the connecting base 1 opposite to the lamp shade 2 sleeves a soft plug 4, one side of the soft plug 4 is provided with a first relief hole 401, the other side of the soft plug 4 is provided with a second relief hole 402, the first relief hole 401 is clamped with the first pin 301 inside, and the second relief hole 402 is clamped with the second pin 302 inside.

As shown in FIG. 6, the soft plug 4 is provided with a second clamping ring 403 at outside, the second clamping ring 403 is clamped inside the second clamping groove 102, and the soft plug 4 is provided with a separator 404 between the first pin 301 and the second pin 302; the separator 404 can prevent the first pin 301 and the second pin 302 from contacting with each other; before the soft plug 4 is stuffed into the connecting base 1, an AB adhesive needs to be injected into the connecting base 1 first, and then the soft plug 4 is used for sealing so as to prevent the lamp bead assembly from falling off; moreover, the first pin 301 and the second pin 302 of the lamp bead are separated so as to avoid short circuit; both the first clamping groove 101 and the second clamping groove 102 have a ring structure, and a middle part at one end of the lamp shade 2 is provided to be a conical groove 203; the soft plug 4 is plugged between the first pin 301 and the second pin 302 so as to play the role of insulating; the first relief hole 401 and the second relief hole 402 are relief holes for the first pin 301 and the second pin 302 to pass through.

To sum up, the two parts adopted in the present disclosure, namely, the connecting base 1 and the lamp shade 2, are made of different materials, and are jointed and assembled to be an integral structure, wherein the lamp shade 2 having an assembled structure can be easily detached and assembled; the connecting base 1 and the lamp shade 2 are in a one-piece structure, which reduces the procedures for assembling the lamp shade 2 so that the lamp shade 2 can be directly used, and the lamp bead body 3, together with the first pin 301 and the second pin 302, penetrates from a tail end of the connecting base 1 until the lamp bead body 3 is inserted into the lamp bead placing groove 201; and then the AB adhesive is injected into the connecting base 1; at last, the soft plug 4 is aligned with and inserted into the tail end of the connecting base 1.

Afore-mentioned are merely preferable embodiments of the present disclosure. It should be noted that, for an ordinary technician in this technical field, improvements and modifications can be made without deviating from the principle of the present disclosure, and should be regarded as within the scope of protection of the present disclosure.

Other parts of the present disclosure that are not explained in detail belong to the prior art, and are not repeated here.

Finally, it should be noted that the above examples are merely used for explaining, rather than limiting, the technical solution of the present disclosure. With reference to the afore-mentioned examples, the present disclosure is described in detail; however, it should be understood by an ordinary technician in this technical field that the technical solution disclosed in the afore-mentioned examples may be modified, or some or all of the technical features thereof can be equivalently replaced, while these modification or replacement shall not cause the essence of corresponding technical scheme to depart from the scope of the technical solution for each example of the present disclosure.

What is claimed is:

1. A string lamp housing structure, comprising:
a connecting base (1) having a hollow sleeve structure;
a lamp shade (2) provided at a front end of the connecting base (1) and being an injection-molded one-piece structure with the connecting base (1);
a lamp bead assembly plugged into the connecting base (1) and having a top end abutting against or provided in the lamp shade (2); and
a soft plug (4) plugged between a first pin (301) and a second pin (302) for insulating;
wherein the lamp shade (2) is sleeved by a lamp shade protection housing (5), and a joint between the connecting base (1) and the lamp shade protection housing (5) is fixed by a convex rib (6).

2. (canceled)

3. The string lamp housing structure according to claim 1, wherein: the lamp bead assembly comprises a lamp bead body (3), the first pin (301) and the second pin (302), the lamp bead body (3) extends through the connecting base (1) into the lamp shade (2), one end of the lamp bead body (3) is connected with the first pin (301), one end shared by the lamp bead body (3) and the first pin (301) is connected with the second pin (302), and both the first pin (301) and the second pin (302) extend out of the connecting base (1).

4. The string lamp housing structure according to claim 3, wherein: one end of the lamp shade (2) at the connecting base (1) is provided with a lamp bead placing groove (201), one end of the lamp shade (2) at the lamp bead placing groove (201) is provided with a first clamping ring (202), one end of the connecting base (1) at the lamp shade (2) is provided with a first clamping groove (101) inside, the first clamping groove (101) is in clamping connection to the first clamping ring (202), the lamp shade (2) is positioned at one end of the first clamping ring (202) at the connecting base (1), and the lamp bead body (3) extends through the connecting base (1) into the lamp bead placing groove (201).

5. The string lamp housing structure according to claim 4, wherein: one end of the connecting base (1) away from the lamp shade (2) is provided with a second clamping groove (102) inside, and one end of the connecting base (1) at the second clamping groove (102) is provided with a reinforcing ring (103).

6. The string lamp housing structure according to claim 4, wherein: one end of the connecting base (1) opposite to the lamp shade (2) sleeves a soft plug (4), one side of the soft plug (4) is provided with a first relief hole (401), the other side of the soft plug (4) is provided with a second relief hole (402), the first relief hole (401) is clamped with the first pin (301) inside, and the second relief hole (402) is clamped with the second pin (302) inside.

7. The string lamp housing structure according to claim 6, wherein: the soft plug (4) is provided with a second clamping ring (403) at outside, the second clamping ring (403) is clamped inside the second clamping groove (102), and the soft plug (4) is provided with a separator (404) between the first pin (301) and the second pin (302).

8. The string lamp housing structure according to claim 5, wherein: both the first clamping groove (101) and the second clamping groove (102) have a ring structure, and a middle part at one end of the lamp shade (2) is provided to be a conical groove (203).

9. The string lamp housing structure according to claim 2, wherein: shapes of the lamp shade protection housing (5) comprise: a ball shape, a water-drop shape, and a bullet shape.

10. The string lamp housing structure according to claim 1, wherein the convex rib is provided on an outer surface of the front end of the connecting base.
